(19) United States
(12) Patent Application Publication
(10) Pub. No.: US 2005/0050454 A1
(43) Pub. Date: Mar. 3, 2005

(54) Controlling the look and feel of a web

(75) Inventors: Aidon Paul Jennery, El Sobrante, CA (US); Melvin Richard Zimowski, San Jose, CA (US)

Correspondence Address: INTERNATIONAL BUSINESS MACHINES CORP;IP LAW, 555 BAILEY AVENUE , J46/G4, SAN JOSE, CA, 95141, US

(73) Assignee: International Business Machines Corporation, Armonk, NY (US)

(21) Appl. No.: 10/651,595

(22) Filed: Aug. 29, 2003

(51) Int. Cl. G06F 15/00

(52) U.S. Cl. 715/513

(57) ABSTRACT

A method, apparatus and article of manufacture, implementing the method, of integrating web applications is provided. In response to a request from a first web application that has a first web page having a first presentation format and a first behavior, in which the request specifies at least one setting, a second web application generates a second web page. The second web application is external to the first web application. The second web page has a second presentation format and a second behavior. The second web page is generated in accordance with the at least one setting, wherein the at least one setting controls, at least in part, at least one of the second presentation format and the second behavior. In another aspect of the invention, the at least one setting comprises one or any combination of a type setting, a style sheet setting and a graphics setting.

### BACKGROUND OF THE INVENTION

1. Field of the Invention

The invention relates to a technique, specifically a method, apparatus, and article of manufacture that implements the method, to control the look and feel of a second web application when integrating the second web application with a first web application where the second web application is external to the first web application.

2. Description of the Related Art

A web application provides users with data that is displayed in a web page having a presentation format with its own “look and feel.” The term “look and feel” refers to the appearance and operation of the web page. For example, “look and feel” comprises the types of objects displayed, the appearance of those objects, and the operation of those objects. The types of objects include, and are not limited to, buttons, lists, tabs, checkboxes, and text fields. The appearance refers to the general appearance of the web page and objects on the page, including, and not limited to, the location of the objects on the web page, the size and color of the objects, whether an object displays a text name (for example, “Apply” or “Cancel” on a button) or whether the object is displayed with graphic image, such as an icon, on that object (for example, an image on a button), the type of font(s) used on a web page, the sizes of the font(s), the color of the font(s), and other font attributes such as bold, italic or underlined. The operation, also referred to as the behavior, refers to how the objects operate, both individually and as a group. Examples of behavior include, and are not limited to, enabling or disabling a response to a click from a mouse on an area of the web page, and how an object responds to a click from a mouse.

When viewing a first web page generated by a first web application, a user may need to access data from a second web application that is integrated with the first web application. The second web application can be invoked from the first web application, and a second web page that is generated by the second web application may be displayed. However, the first and second web pages may have different presentation formats and behaviors. Colors, fonts, the types of objects displayed, their locations on the web page, and the attributes of the objects may differ. Thus the user is not provided with a consistent, that is, seamless “look and feel” in the web environment, even though the web applications are integrated.

More generally, the first web application cannot control the “look and feel” of the second web application. However, some software vendors sell integrated systems and want to provide a consistent or controlled “look and feel” among the web applications. In other words, these software vendors want to provide a user with a seamless or otherwise controlled web experience, even though that vendor is using other vendor's software.

Therefore there is a need for a method, apparatus and article of manufacture that implements the method, for integrating a second web application with a first web application to control the “look and feel” of the second web application.

### SUMMARY OF THE INVENTION

To overcome the limitations in the prior art described above, and to overcome other limitations that will become apparent upon reading and understanding the present specification, the present invention discloses a method, apparatus, and article of manufacture for controlling the look and feel of a second web application when integrating the second web application with a first web application.

In accordance with the present invention, a method of controlling at least one of a presentation format and a behavior of a web page of a web application is provided. In response to a request from a first web application that has a first web page having a first presentation format and a first behavior, in which the request specifies at least one setting, a second web application generates a second web page. The second web application is external to the first web application. The second web page has a second presentation format and a second behavior. The second web page is generated in accordance with the at least one setting, wherein the at least one setting controls, at least in part, at least one of the second presentation format and the second behavior. In another aspect of the invention, the at least one setting comprises one or any combination of a type setting, a style sheet setting and a graphics setting. In this way, a configurable web environment is provided.

In yet another aspect of the invention, the second presentation format and second behavior is substantially similar to the first presentation format and first behavior. In this way, the user is provided with a seamless web experience. The look and feel of the graphical user interface of the second web application is controlled when the second web application is integrated with a first web application that is external to the second web application.

### BRIEF DESCRIPTION OF THE DRAWINGS

The teachings of the present invention can be readily understood by considering the following detailed description in conjunction with the accompanying drawings, in which:

FIG. 1 depicts a high-level flowchart of an embodiment of a technique to control the “look and feel” of a second web application when integrating with a first web application;

FIG. 2 depicts a high-level block diagram of an embodiment of a web application environment that uses the technique of FIG. 1;

FIG. 3 depicts a block diagram of an embodiment of the architecture of an exemplary web application environment in which a second exemplary web application is integrated with a first exemplary web application to control the “look and feel” of the second web application;

FIG. 4 depicts an exemplary first web page generated by an exemplary first web application that is integrated with a second exemplary web application, prior to the execution of the second exemplary web application.

FIG. 5 depicts the exemplary first web page of FIG. 4 following the execution of the second exemplary web application which generates the second web page, displaying a list of search results within the first web page;

FIG. 6 depicts a high-level flowchart of an embodiment of a technique to generate and display a list of search results using a controlled presentation format and a controlled behavior;

FIG. 7 depicts a more-detailed flowchart of an embodiment that uses at least one specified setting to generate the second web page;

FIG. 8 depicts a more-detailed flowchart of another embodiment of using at least one specified setting to generate a second web page;

FIG. 9 depicts an exemplary web page that displays an individual search item in a separate window;

FIG. 10 depicts a high-level flowchart of an embodiment of a technique to display the individual search item of FIG. 9; and

FIG. 11 depicts an illustrative computer system that uses the teachings of the present invention.

To facilitate understanding, identical reference numerals have been used, where possible, to designate identical elements that are common to some of the figures.

### DETAILED DESCRIPTION OF THE PREFERRED EMBODIMENTS

After considering the following description, those skilled in the art will clearly realize that the teachings of the present invention can be utilized to control the “look and feel” of a second web application when integrating the second web application with a first web application, where the second web application is external to the first web application.

A technique, specifically a method, apparatus, and article of manufacture that implements the method, controls at least one of the presentation format and the behavior of a web page of a web application. In response to a request from the first web application in which the request specifies at least one setting to control, at least in part, at least one of the presentation format and the behavior, the second web application generates a second web page that has a second presentation format and a second behavior. The second web application generates the second web page such that at least one of the second presentation format and the second behavior is in accordance with the setting(s). In this way, the first web application can control, at least in part, the “look and feel” of a web page generated by the second web application.

In another embodiment, at least one of the second presentation format and the second behavior is substantially similar to the first presentation format and the first behavior. The terms “substantially similar look and feel” or “substantially similar presentation format and behavior” refer to using the same or substantially similar objects, object size, graphics, page layout, font, colors, text, audio and video, and operation as the first web application in the second web application. In this way, a user is presented with a seamless, that is, a consistent, “look-and-feel” when using integrated web applications.

In yet another more particular embodiment of the invention, the technique provides a configurable method and framework to provide the “look and feel” of a web application that is being extended. In other words, a first web application is integrated with, that is, extended by, a second web application. The technique uses an integrator, in one embodiment, a Java servlet in the second web application, to establish an execution environment for locating and providing access to both structured and unstructured data, and one or more servlets and JavaServer Pages (JSP) for generating a web page to display the data based on the following configuration settings: (1) a type setting that controls the objects that appear and the capabilities that are supported within the web page(s) generated by the JSP, (2) a style sheet setting that selects a style sheet specifying fonts and colors similar to those of the first web application, and (3) for a web application that uses graphics in its web pages, a graphics setting that selects graphics similar to those of the first web application. In another embodiment, a print-enabled setting determines whether a print button will appear on the web page. The configuration settings are specified in a properties file. In one embodiment, the properties file specifies one or any combination of the type setting, the style sheet setting and the graphics setting. When the first web application makes a request for data from the second web application, the request specifies a properties file. In the second web application, the integrator accesses the specified properties file to determine the values of the settings. In another embodiment, the technique permits the simultaneous integration of the first web application with multiple external applications.

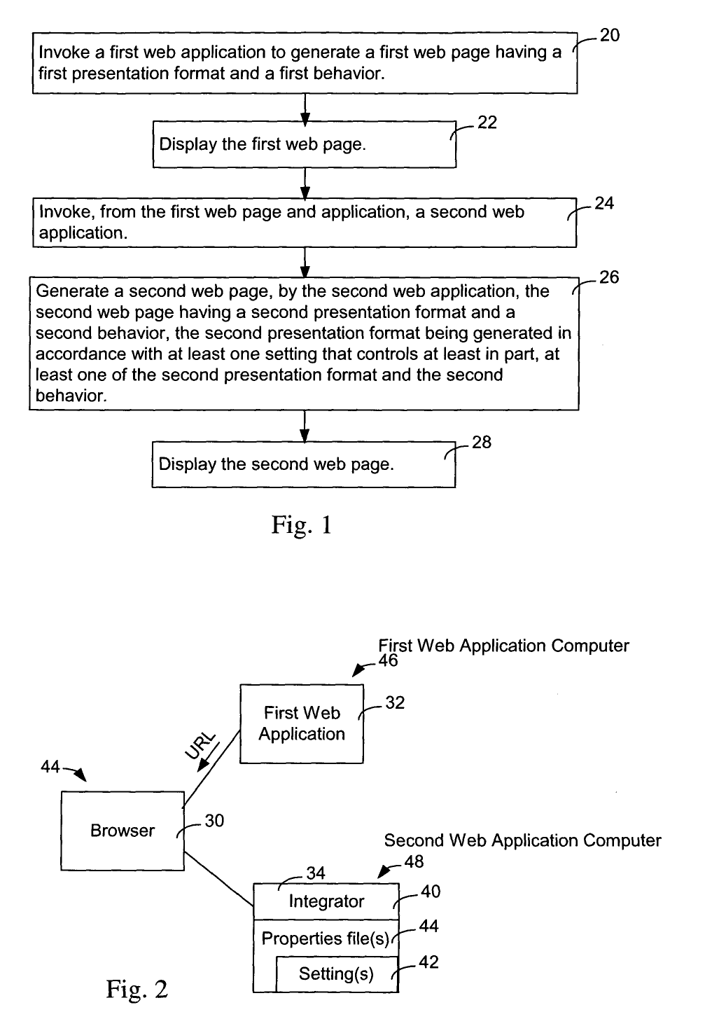

Referring to FIG. 1, a high-level flowchart depicts an embodiment of the technique of the present invention. Referring also to FIG. 2, a high-level block diagram of a web application environment is shown. In step 20, a user at a browser 30, invokes a first web application 32 to generate a first web page having a first presentation format and a first behavior. In step 22, the browser 30 displays the first web page. In step 24, the user invokes, from the first web page and the first web application 32, a second web application 34. The first web application 32 provides a uniform resource locator (URL) that is sent to the browser 30 which invokes the second web application 34 with the URL. In step 26, in the second web application 34, the integrator 40, receives at least one setting via the URL, and causes the second web page to be generated. The second web page has a second presentation format and a second behavior. The second web page is generated in accordance with at least one setting 42 that controls, at least in part, at least one of the second presentation format and second behavior. In an alternate embodiment, the setting controls the second presentation format and the second behavior such that at least one of the second presentation format and second behavior is substantially similar to the first presentation format and first behavior.

The first web application, the browser and the second web application may be on the same computer. Typically the first web application 32, the browser 30, and the second web application 34 are on different computers, a first web application computer 46, a browser computer 44, and a second web application computer 48, respectively.

The first web application 32 is configured to invoke the second web application 34 and to specify a properties file 44 to use. In one embodiment, the web page generated by the first web application 32 is provided with a control object, for example, a button, that when clicked on, causes a URL to be returned to the web page browser 30 to invoke the second web application 34.

In one embodiment, the settings are specified indirectly. In particular, the URL from the first web application 32 specifies the setting(s) 42 by specifying a properties file 44 that stores the values of the setting(s) 42. Alternately, the settings may be specified directly in the URL.

The invention may be used with both structured and unstructured data. Structured data comprises data stored in traditional databases. Unstructured data comprises data with an unstructured digital content such as text, HTML files, document images, audio and video data.

In another embodiment, the first web application provides a first set of data in the first web page having the first presentation format and the first behavior. The second web application provides a second set of data. The second web page comprises at least a subset of the second set of data having at least one of the second presentation format and second behavior in accordance with the setting(s). The first set of data is structured data and the second set of data is unstructured data. Alternately, the first set of data is structured data and the second set of data is structured data about unstructured data. In another alternate embodiment, the unstructured data is displayed from the second set of data.

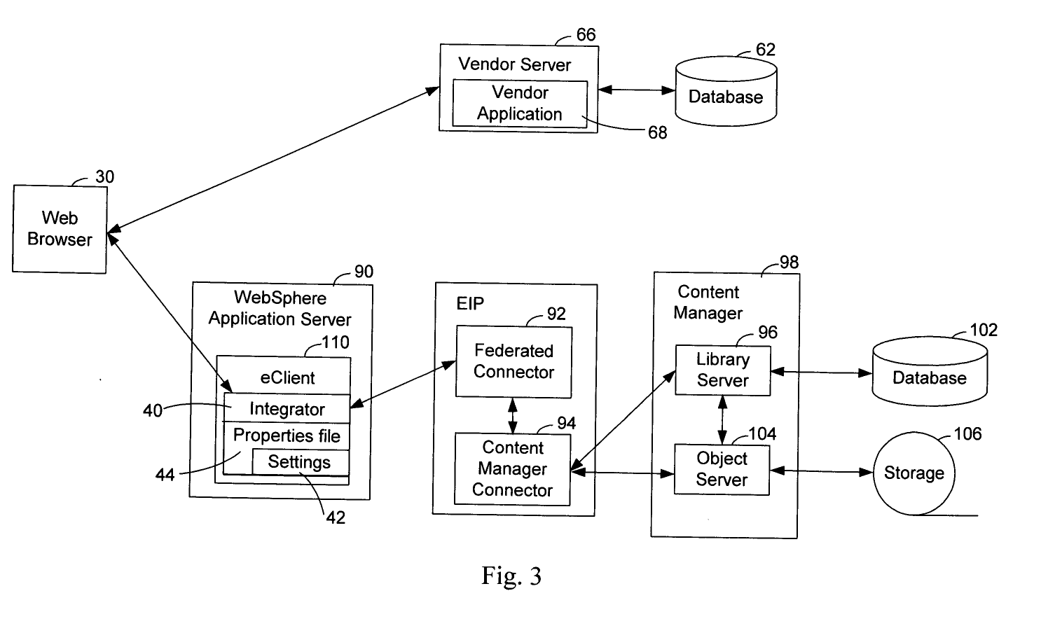

Referring to FIG. 3, an embodiment of an exemplary web application environment is shown. In one embodiment, the first exemplary web application is a Siebel® (Siebel is a registered trademark of Siebel Systems, Inc.) Customer Relationship Management (CRM) application and the second exemplary web application comprises an IBM® (IBM is a registered trademark of International Business Machines Corporation) Content Manager application called IBM Content Manager Integration for Siebel, which installs as part of the IBM Content Manager eClient 110. In another embodiment, the first web application is a PeopleSoft® application (PeopleSoft is a registered trademark of PeopleSoft, Inc.), such as PeopleSoft Enterprise Portal and PeopleTools® (PeopleTools is a registered trademark of PeopleSoft, Inc.), and the second web application is IBM Content Manager Integration for PeopleSoft. However, the invention is not meant to be limited to these Siebel, PeopleSoft and IBM applications, and the invention may be used with other web applications.

A user with a web browser 30 is connected to a vendor application 68 executing on a vendor server 66 which can access a datastore 62. For example, the user may be looking at a list of service requests for which the user is responsible. Clicking on a service request in the web browser 30 causes a request for information about the service request to flow to the vendor server 66 and the result to be returned back to the web browser.

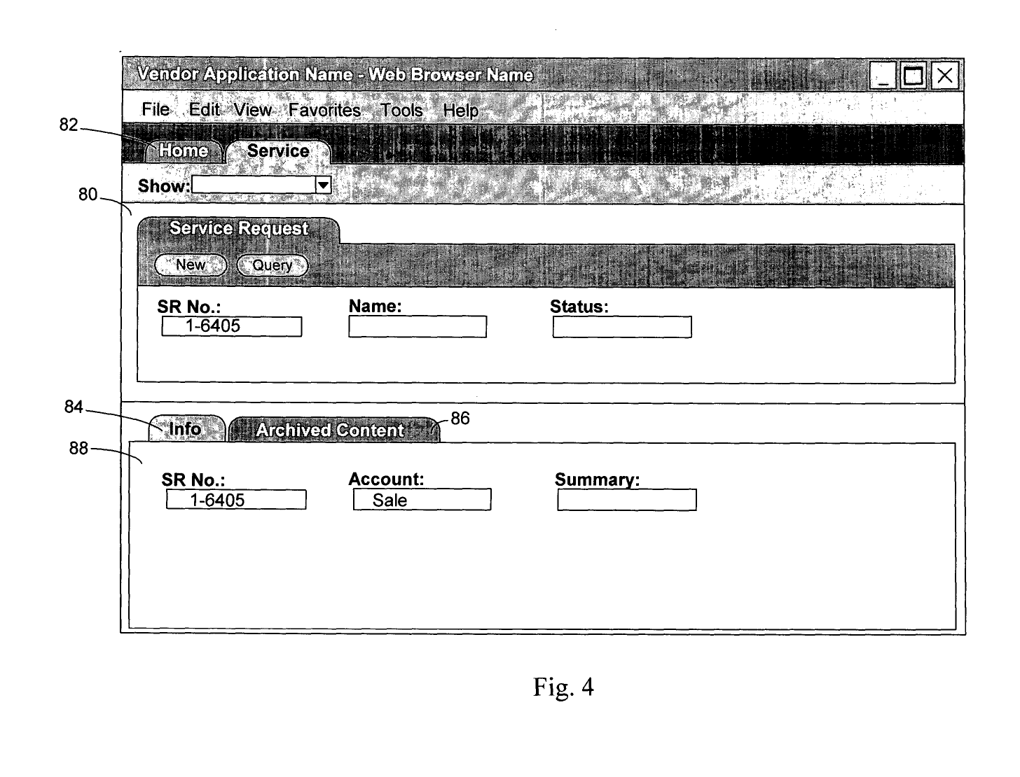

Referring also to FIG. 4, an exemplary web page, that is, a screen 80, of a vendor application that can display data from the IBM Content Manager is shown. A first set of tabs 82 provides a list of screens. A second set of tabs 84 provides a list of views. In one embodiment, as shown in FIG. 4, in the web page, an “Archived Content” tab 86 has been configured to cause the integrator to be invoked. The integrator 40 accesses the Content Manager 98 to retrieve data to display on a web page. An iFrame 88 is associated with the archived content tab 86. The iFrame 88 provides an area on which a web page generated, or caused to be generated, by the integrator 40 can be displayed.

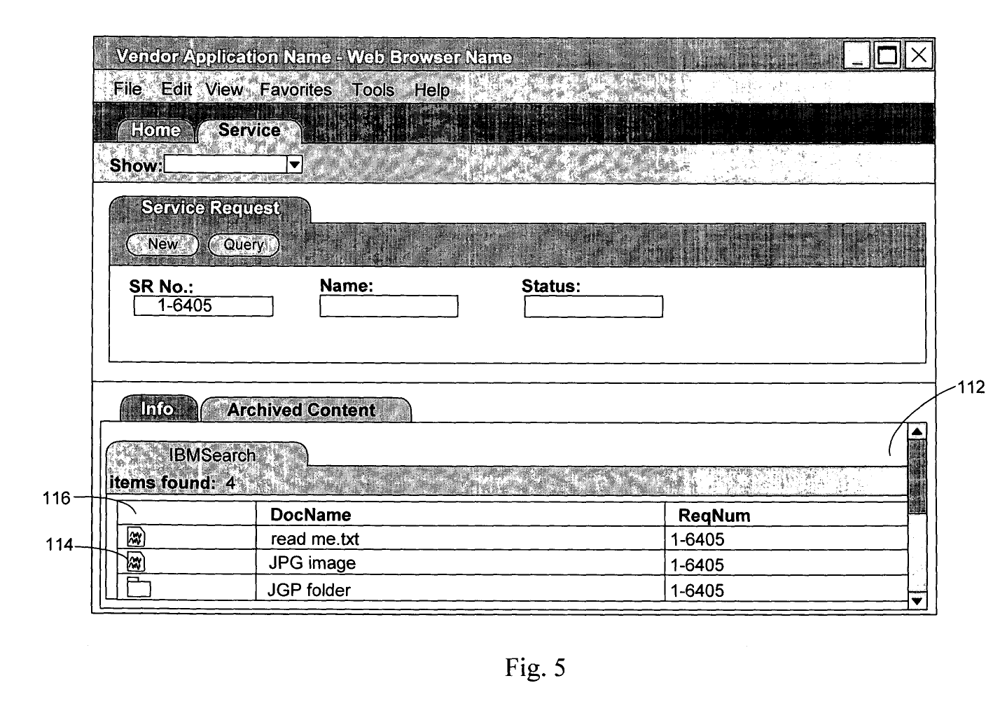

When the user activates the “Archived Content” tab 86 in the web browser 30, a request is sent to the vendor server 66 which evaluates a calculated field URL. In this example, the vendor server 66 also substitutes the appropriate service request number in the calculated field URL. The calculated field URL is returned to the web browser 30. The web browser 30 loads the calculated field URL, which causes the request to be handled by the integrator 40 which is running as a web application in an application server. In one embodiment, the application server is an IBM WebSphere® application server 90 (WebSphere is a registered trademark of IBM Corporation). In an alternate embodiment, an application server other than the IBM WebSphere application server may be used. In one embodiment, the integrator 40 generates a search template and invokes an IBM Enterprise Information Portal (EIP) Federated Connector 92, which invokes the IBM Content Manager Connector 94 which uses the search template to execute a search on a Content Manager Library Server 96 for content associated with the specified service request. In the Content Manager 98, the Content Manager Library Server 96 accesses a Content Manager database 102, and a Content Manager Object Server 104 accesses Content Manager Storage 106. In FIG. 5, an exemplary web page 112, containing a list of Content Manager documents that match the service request, is returned and displayed in the web browser 30. The list of documents comprises structured data that references unstructured data. The vendor web application 68 is configured to invoke the integrator 40.

In one embodiment, the integration of the vendor application with IBM Content Manager 98 is achieved through customization of at least one component within a particular object layer of the vendor application 68. The customization adds one or more calculated fields, each of which contains a calculated field URL. The display of each calculated field value by the vendor application is achieved by (1) associating the calculated field with a control within a vendor applet that uses a web template to display the calculated field, and (2) adding the vendor applet to a view associated with the object that contains the component of interest. The value of the calculated field URL will be the HTML results, that is, the web page that is generated by the integrator that contains the result of a federated search of the IBM Content Manager content store. In one embodiment, the calculated field URL has the following format:
<URL scheme>://<virtual host name>/<eClient application name>/Integrator?<arguments>

The virtual host name is the name of the eClient server 110 containing the integrator 40. The calculated field URL is the interface that the vendor application 68 uses to invoke the integrator 40 of the eClient server 110. The vendor System Administrator defines the values of the arguments within the URL when adding the calculated field URL to the business component. The values of the arguments specify the search criteria for the federated search that will be initiated by the integrator 40 as well as at least one setting that controls at least one of the presentation format and the behavior of the web page.

Each of the arguments within the calculated field URL will now be described. Table 1 below illustrates the arguments of an embodiment of the calculated field URL.

TABLE 1
Arguments of a Calculated Field URL

| Argument Name | Argument Value |
|---|---|
| eClientToken | <installation provided token> |
| IPFile | <name of Integrator Properties file> |
| Entity | <name of federated search template> |
| <search criterion name> | <search criterion value> |
| ReleaseLevel | <release level of vendor server> |
| Server | <name of federated server database> |
| Userid | <userid for access to federated server database> |
| Password | <password for access to |
| | federated server database> |

The eClientToken argument is used to control access to the Content Manager's content servers. The eClientToken argument value is provided in the URL by the vendor application 68 when the application attempts to access any supported content servers. An exemplary eClientToken argument and property value is shown below:
eClientToken=integrator

During integrator configuration, a system administrator selects a value for the eClientToken property and adds the value to the properties file 44 for the associated application. This same value of the eClientToken property is provided in the eClientToken argument of the calculated field URL.

In the calculated field URL, the IPFile argument specifies the name of the integrator properties file that is to be used when generating the web page that contains the search results. The integrator 40 adds the file extension “properties” to the name specified by the IPFile argument. For example, if the name specified by the IPFile argument is equal to Vendor, then the integrator 40 will attempt to read the properties and settings from the Vendor.properties file. The integrator 40 assumes that the integrator properties file is in the same directory as an eClient properties file, called IDM.properties. For example, if the eClient root directory is <drive>:\Program Files\CMeclient, then the properties file is placed in the directory <drive>:\Program Files\CMeclient.

The Entity argument specifies the name of a search template for a federated search.

The <search criterion name> argument(s) specify the values for the search criterion defined in the search template. The <search criterion name> arguments have the following syntax:
<search criterion name>=<search criterion value>.

The ReleaseLevel argument specifies the release level of the first web application.

Argument name/value pairs are separated by the character “&” within the query string of the URL.

Configuring the Integrator

During integrator 40 configuration, an administrator specifies values for the properties in an application-specific properties file that is specified by an external application. The properties file contains the following properties and settings:

(1) An eClientToken property is an administrator-selected token that is provided by an external application when invoking the integrator 40. The integrator 40 for IBM Content Manager compares the value of the eClientToken argument provided in the URL with the value of the eClientToken property in the properties file 44. The integrator permits access to the data in the Content Manager when these two values of eClientToken match. The matching of eClientToken values provides access security. The eClientToken property is case-sensitive. Valid characters for the eClientToken property are any of the ISO 8859-1 Latin 1 characters with the exception of “;”, “/”, “?”, “:”, “@”, “&”, “=”, “+”, “,” and “$”, which are reserved characters within the query string of a URL. During integrator configuration, the system administrator selects a value for the eClientToken property and adds the value to the properties file 44 for the associated application.

(2) A server property specifies the name of the federated server database that the integrator 40 will access. In an alternate embodiment, the integrator assumes a single federated data store.

(3) A user identifier (userid) property specifies a userid to use to access the federated server database.

(4) A password property provides a password for the userid that will be used to access the federated server database.

(5) A type setting specifies some of the characteristics of at least one of the presentation format and the behavior of the web page(s) that will be generated by one or more JavaServer Pages. In one embodiment, the value of the type setting controls at least one or any combination of the following: whether a web page has certain control objects, such as toolbars and buttons, how search result lists are displayed, and whether buttons are identified with text labels or graphics. In one embodiment, for one vendor application, the value of type setting is equal to one.

(6) A cssPrefix setting specifies a file name prefix for a cascading style sheet file that will used by the JavaServer Pages to generate a web page. The cascading style sheet affects the appearance of the web pages by specifying the use of at least one of or any combination of: text fonts, colors, margins, position of text, and alignment of text, such as left, center or right. In one embodiment, an application-specific cascading style sheet uses text fonts, colors, margins, position of text, and alignment of text that are substantially similar to those used in the vendor application web pages. In an alternate embodiment, the application-specific cascading style sheet uses text fonts, colors, margins, position of text, and alignment of text that are different from the vendor application web pages, but selected for that vendor application. In one embodiment, the default css_prefix value for one vendor application is alt1.

(7) An iconPrefix setting specifies a file name prefix for the graphics or icon files used by the JSP to generate the web page. In one embodiment, the icon files provide icons, for example, a “go” button, with a similar appearance to the icons of a vendor application web page. Alternately, the icon files provide icons with a different appearance from the vendor application web page, but selected for that vendor application. In one embodiment, the default icon_prefix value for one vendor application is “alt1.”

(8) A printEnabled setting specifies whether a print capability will be provided in the toolbar of a Document Viewer. When the value of printEnabled is equal to TRUE, a print button will be displayed on a web page. In one embodiment the printEnabled setting is optional. In an alternate embodiment, the printEnabled setting is not used.

A portion of an exemplary properties file is shown below.

#-----------------------------------------------------------------------------------------------------------------------------
# eClientToken is selected by a system administrator and is provided by the vendor application when
# attempting to access Content Manager. An Integrator servlet compares the token provided
# in the URL with the token specified in this properties file. Valid characters for the eClientToken are any
# of the ISO 8859-1 Latin 1 characters with the exception of “;”, “/”, “?”, “:”, “@”, “&”, “=”, “+”, “,”, and
# “$”, which are reserved characters within the query string of a URL.
#-----------------------------------------------------------------------------------------------------------------------------
eClientToken=mytoken
#-----------------------------------------------------------------------------------------------------------------------------
# server specifies the name of the federated server database that the Integrator servlet will access.
#-----------------------------------------------------------------------------------------------------------------------------
server=idmserver
#-----------------------------------------------------------------------------------------------------------------------------
# userid specifies the userid that will be used to access the federated server database.
#-----------------------------------------------------------------------------------------------------------------------------
userid=username
#-----------------------------------------------------------------------------------------------------------------------------
# password specifies the password for the userid that will be used to access the federated server database.
#-----------------------------------------------------------------------------------------------------------------------------
password=mypassword
#-----------------------------------------------------------------------------------------------------------------------------
# type controls the objects that appear and the capabilities that are supported within a web page that is
# generated by the JSP.
# A value of 1 specifies the following:
# (1) The removal of the search entity tab
# (2) The removal of the search results toolbar
# (3) A tabular display of the search results
# (4) The elimination of “white space” borders around search result lists
# (5) The disablement of the page context menu
# (6) The use of graphical rather than text buttons
#-----------------------------------------------------------------------------------------------------------------------------
type=1
#-----------------------------------------------------------------------------------------------------------------------------
# cssPrefix specifies a file name prefix for the Cascading Style Sheet file that will be used by the JSP. The
# specification determines the text fonts, colors, etc. that are used.
# A value of alt1 specifies the use of alt1 IDM.css.
#-----------------------------------------------------------------------------------------------------------------------------
cssPrefix=alt1
#-----------------------------------------------------------------------------------------------------------------------------
#
# iconPrefix specifies a file name prefix for the icon files that will be used by the JSP.
# A value of alt1 specifies the use of gif files with names prefixed by the character string alt1. These gif
# files contain graphical buttons for the document viewer toolbar.
#-----------------------------------------------------------------------------------------------------------------------------
iconPrefix=alt1
#-----------------------------------------------------------------------------------------------------------------------------
# printEnabled specifies whether a print capability will be included in the toolbar of the Document Viewer.
# Valid printEnabled values are (true|false).
# A value of true specifies the inclusion of the print button.
# A value of false specifies the omission of the print button.
#-----------------------------------------------------------------------------------------------------------------------------
printEnabled=false
#-----------------------------------------------------------------------------------------------------------------------------

In an alternate embodiment, the settings of the properties file are optional. In another embodiment, the properties file comprises at least one or any combination of the type, cssPrefix and iconPrefix settings. In another alternate embodiment, the settings are specified directly in the URL as arguments, rather than specifying the settings using the properties file.

The Integrator

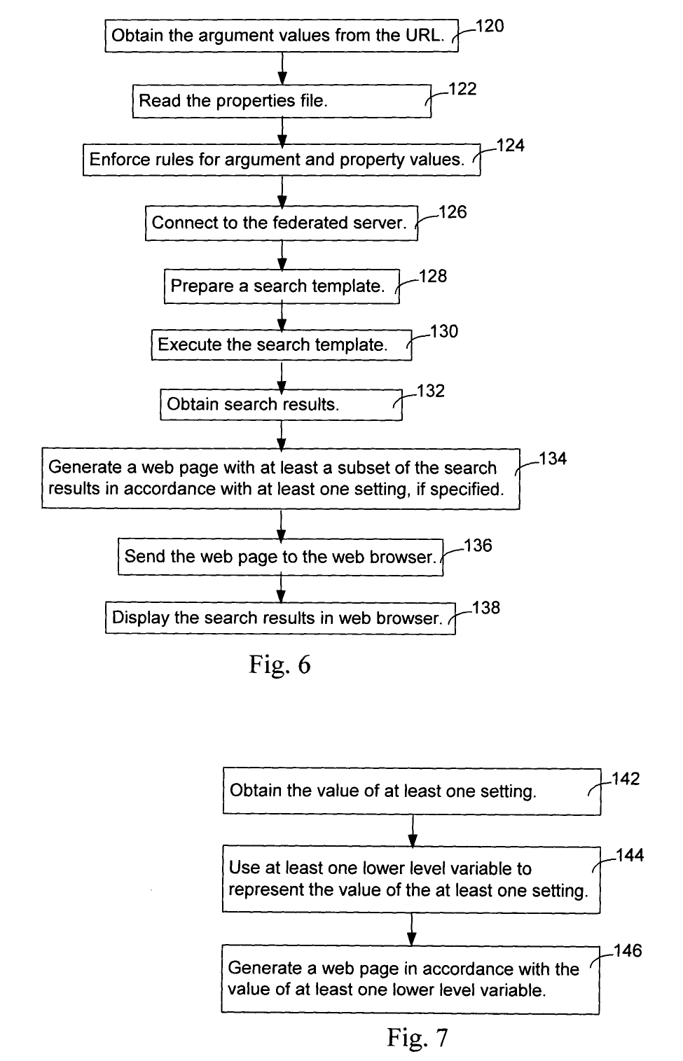

Referring to FIG. 6, a high-level flowchart depicts an embodiment of a technique to generate and display a list of search results in at least one of a configurable presentation format and a configurable behavior having a “look and feel” that, in one embodiment, is substantially similar to the “look and feel” of a first web application. In one embodiment, the integrator is implemented as a servlet.

In step 120, the integrator obtains the argument values, as described above with respect to Table 1, from the calculated field URL. One argument of the calculated field URL specifies the prefix of the name of the properties file to use, and the name of the properties file is generated as described above. Alternately, the entire properties file name is specified in an argument of the calculated field URL. In step 122, the integrator reads the properties file that was specified as an argument in the URL, and extracts the values of the properties such as the setting(s) from the properties file.

In step 124, the integrator enforces rules for argument and property values. If a rule is violated, the integrator returns an error. If no rules are violated, the integrator stores the settings and other properties in a servlet context in a manner that associates names and values. The servlet context is part of the state information associated with the servlet, and can be shared among servlets and JavaServer Pages.

In step 126, the integrator connects to the federated server. In step 128, the integrator prepares a search template. In step 130, the integrator executes the search. In step 132, the integrator obtains the search results. The search results are structured data about unstructured data. In an alternate embodiment, the search results are unstructured data.

In step 134, a web page containing the search results is generated, at least in part, in accordance with at least one of the settings of the properties file. In one embodiment, the integrator causes the web page to be generated by invoking one or more servlets and JavaServer Pages to generate the web page with the search results. In another embodiment, the integrator causes the web page to be generated within an application server, such as a WebSphere Application Server, execution environment by invoking one or more servlets and JavaServer Pages to generate the web page with the search results. In step 136, the generated web page is sent to the browser. In one embodiment, the integrator causes the generated web page to be sent to the browser. In an alternate embodiment, the integrator causes the application server, such as the WebSphere application server, to send the generated web page to the browser in the application server execution environment.

In step 138, the browser displays the web page. For example, as shown in FIG. 5, at least a subset of the search results are displayed with a substantially similar look and feel as the existing application.

Referring to FIG. 7, a flowchart depicts an embodiment of a technique to implement step 134 of FIG. 6. In one embodiment, the flowchart is implemented in at least one JSP. In step 142, the JSP obtains the value of at least one setting. In one embodiment, the JSP obtains the value from the Servlet Context, described above. In step 144, the JSP uses at least one lower level variable, associated with a respective setting, to store a value in accordance with the value of the setting. The value of the lower level variable is subsequently used during JSP execution. In one embodiment, the lower level variables are used in the JSP body to generate the web pages. In step 146, the JSP generates a web page in accordance with the value of the at least one lower level variable.

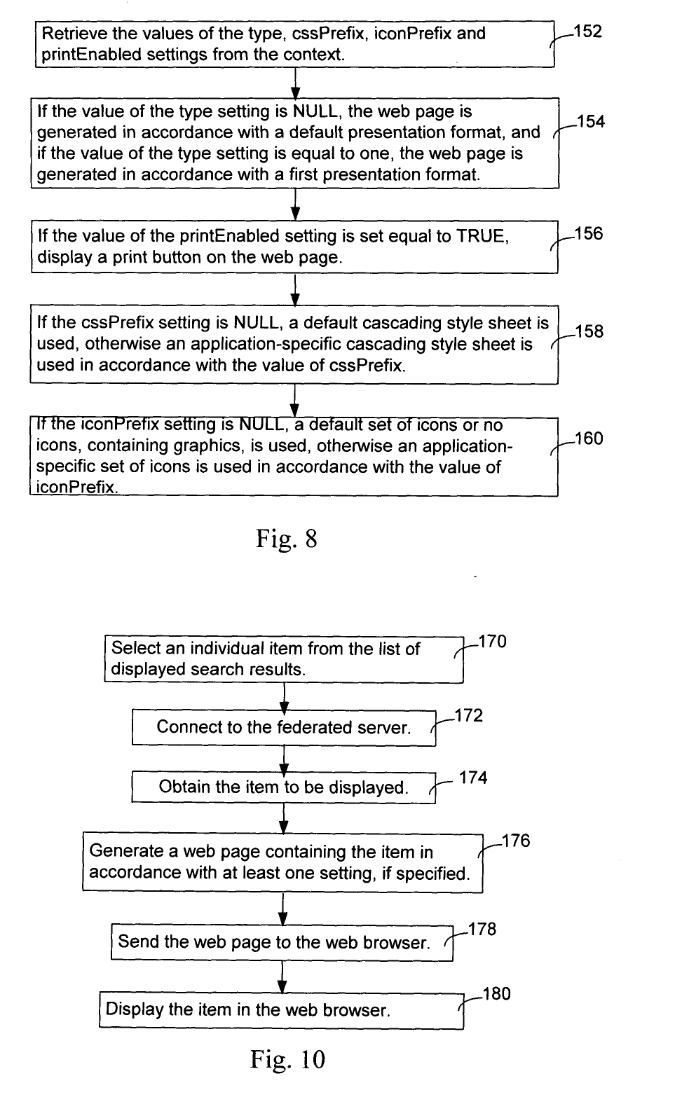

Referring to FIG. 8, a more-detailed flowchart depicts an embodiment of a technique to implement step 134 of FIG. 6. In step 152, the values of the type, cascading style sheet prefix (cssPrefix), graphics file prefix (iconPrefix) and print enabled (printEnabled) settings are retrieved from, for example, the servlet context.

In step 154, if the value of the type setting is NULL, the portion of the presentation format and the behavior that is controlled by the type setting is a default presentation format and a default behavior. In one embodiment, a default presentation format and a default behavior generates a “search entity” tab, a “search results” toolbar, the search results, white space borders around the search results, a page context menu, text buttons, and uses the default cascading style sheet, and default “gif” files.

In one embodiment, if the value of the type setting is equal to one, the web page is generated in accordance with a first presentation format and a first behavior. In one embodiment, the first presentation format and the first behavior comprise the following:
(1) The removal of a “search entity” tab;
(2) The removal of a “search results” toolbar;
(3) A tabular display of the search results;
(4) The elimination of “white space” borders around search result lists;
(5) The disablement of the page context menu; and
(6) The use of graphical rather than text buttons.

Alternately, if the value of the type setting is equal to three, a Content Manager logoff button is not displayed. In another embodiment, the type setting causes the generated web page to be displayed in a window provided by the calling program, rather than a generating a separate window to display the generated web page.

In step 156, if the printEnabled setting is set to TRUE, a print button will be displayed to allow the user to print individual documents contained in the search results. If the printEnabled setting is set to false, no print button will be displayed and the user will not be able to print the documents contained in the search results. An associated lower level print variable is populated with a value representing the printEnabled setting. Based on the value of the lower level print variable, a print button will or will not be generated in the web page.

In step 158, if the cascading style sheet setting, in a variable called cssPrefix, is NULL, a default cascading style sheet is used, otherwise an application-specific cascading style sheet is used in accordance with the value of cssPrefix. The cssPrefix variable is populated with the value of the cascading style sheet. Using the value of cssPrefix as a prefix, a filename of a cascading style sheet is generated. For example, if the value of the cssPrefix variable is “alt1”, the filename of the associated cascading style sheet is alt1IDM.css. The cascading style sheets are stored in a predetermined target directory. When generating the web page, the generated cascading style sheet filename specifies the cascading style sheet.

In step 160, if the graphics setting, in a variable called iconPrefix, is NULL, a default set of icons, containing graphics, are used. For example, an icon may be used on a button, rather than text. In an alternate embodiment, no icons are used. An associated lower level iconPrefix variable is populated with the value of iconPrefix. Using the value of the iconPrefix variable as a prefix, at least one filename of an icon file is generated. For example, if the value of the iconPrefix variable is equal to “alt1”, the filename of an associated icon file is “alt1buttonLeft_a.gif”. The file names of the icon files are stored in lower level icon filename variables. The icon files are stored in a predetermined target directory. When generating an object on the display that is associated with an icon, the JSP specifies the directory and the name of the lower level icon filename variable that contains the name of the icon file to use with the object.

The steps of FIG. 8 may be implemented in a single JSP. Alternately, each step or a combination thereof may be implemented in multiple JSPs.

The following exemplary portion of a JSP illustrates another embodiment of the present invention. In the following JSP, the specified properties filename is in the session state, and the values from the properties file have been stored in the servlet context. A lower level variable called bodyAttrs is derived from the value of the type setting from the servlet context and is used to disable the right click in the web page. In addition to the bodyAttrs variable as described above, the cascading style sheet setting from servlet context is used to determine the cascading style sheet prefix variable to derive the name of the cascading style sheet. To more easily identify the lower level variables, the lower level variables are shown in bold text.

```
@@@@@@@@@@@@@@@@@@@@@@@@@@@@@@@@@@@@@@
    //
    // First, the integration properties filename (IPFile) is obtained from the session
    // state (cub). Then up to four values are obtained from the servlet context (cvb).
    // The names of these values are prefixed with IPFile and a period. The code uses
    // the values to set lower level variables that are used by the JSP.
    String ipFile = cub.get( IDMServletConstants.PARM_IPFILE );
    String cssPrefix = “”;
    String bodyAttrs = “”;
    String frameSetRows = “85,35,*”;
    String cssName = null;
    if ( ( ipFile != null ) && ( !ipFile.equals( “” ) ) ) {
      String pType = null;
      pType = cvb.get( ipFile + “.” +
IDMServletConstants.PROP_INTEGRATOR_TYPE );
      cssPrefix = cvb.get( ipFile + “.” +
IDMServletConstants.PROP_INTEGRATOR_CSS_PREFIX );
      if ( ( pType != null ) && ( pType.equals( “1” ) ) ) {
        bodyAttrs = “oncontextmenu=\”return false;\“”;
        frameSetRows = “0,0,*”;
      }
      if ( cssPrefix == null ) {
        cssPrefix = “”;
      }
    }
    cssName = “/” + cssPrefix + “eclient81.css”;
    //
@@@@@@@@@@@@@@@@@@@@@@@@@@@@@@@@@@@@@@@
...
</script>
<head>
    <title><%= cub.getIdmResourcesString(“IDMSearchToolbarJSP_TitleBar”)
%></title>
    <link rel=“STYLESHEET” type=“text/css” href=“<%= webAppName
%><%=cssName%>”>
</head>
    <frameset rows=“<%= frameSetRows %>” framespacing=“0” border=“0”
title=“Search Frame Results” onLoad=“begin( );” onUnload=“cleanup( );”>
    <frame noresize title=“ResultsToolbar” name=“ResultsToolbar” src=“<%=
webAppName %>/IDMSearchToolbar.jsp?action=init” marginwidth=“0”
marginheight=“0” scrolling=“auto” frameborder=“no”>
    <frame noresize title=“Searching” name=“Searching” src=“<%= webAppName
%>/IDMSearching.jsp” marginwidth=“0” marginheight=“0” scrolling=“no”
frameborder=“no”>
    <frame noresize title=“ResultsBottom” name=“ResultsBottom” src=“<%=
webAppName %>/IDMSearchResults.jsp?srKey=<%= srKey %>” marginwidth=“0”
marginheight=“0” scrolling=“auto” frameborder=“no”>
    <noframes>
        <body <%= bodyAttrs %>>
            <h2><%= cub.getIdmResourcesString(“FrameAlertTitle”) %></h2>
            <p><%= cub.getIdmResourcesString(“FrameAlertText”) %></p>
        </body>
    </noframes>
</frameset>
</html>
<% if (trcLogger.isLogging) trcLogger.text(IRecordType.TYPE_API,
cub.getClassName( ), IDMServletUtils.getID(request), “Exit”); %>
```

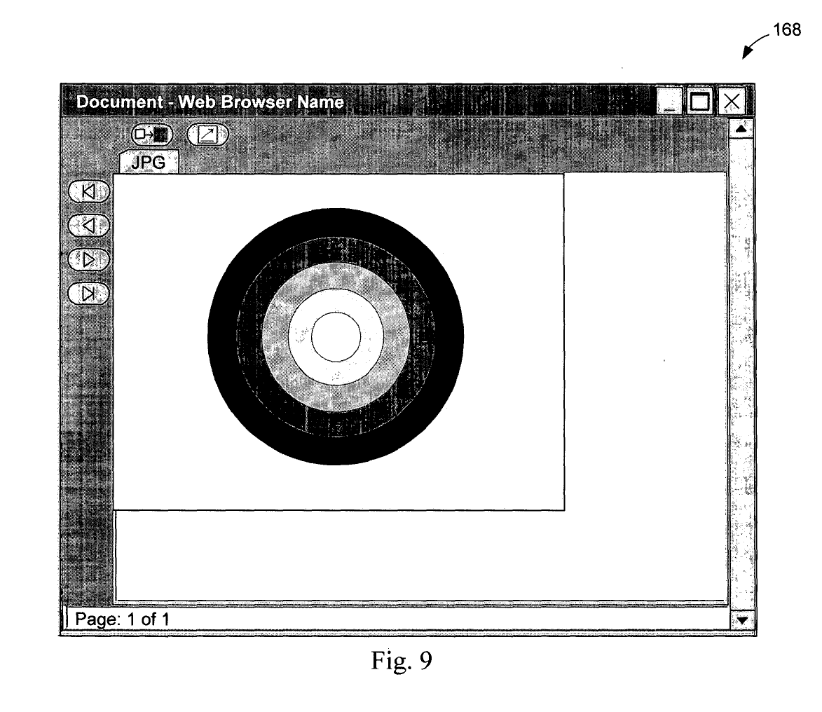

Referring back to FIG. 5, a screen depicts an exemplary web page that was generated by at least one JSP. Clicking on a document icon 114 in the search results list 116 causes the document to be displayed via a document viewer. Referring to FIG. 9, an exemplary document viewer 168 displays a selected document.

Referring to FIG. 10, a flowchart illustrates an embodiment of the generation of a web page containing the document to be displayed. The document is displayed in its own separate web page and is not embedded within another web page.

In step 170, a user selects an individual item from the list of displayed search results, for example, by clicking on that item. In step 172, the integrator connects to the federated server. In step 174, the integrator obtains the item to be displayed. The item to be displayed is unstructured data. Alternately, the item to be displayed comprises structured data. In one embodiment, as shown in FIG. 9, the item is an image. In an alternate embodiment, the item may comprise other types of unstructured data.

In step 176, a web page containing the item is generated based on at least one setting, if specified in either the properties file or the URL. In one embodiment, the integrator causes the web page to be generated by invoking at least one servlet and/or JSP to generate the web page. In another embodiment, the integrator causes the web page to be generated within an application server, such as the WebSphere application server, execution environment by invoking at least one servlet and/or JSP to generate the web page. In step 178, the generated web page is sent to the web browser. In one embodiment, the integrator causes the generated web page to be sent to the web browser. In an alternate embodiment, the integrator causes the application server, such as the WebSphere application server, to send the generated web page to the web browser. In step 180, the web browser displays the web page.

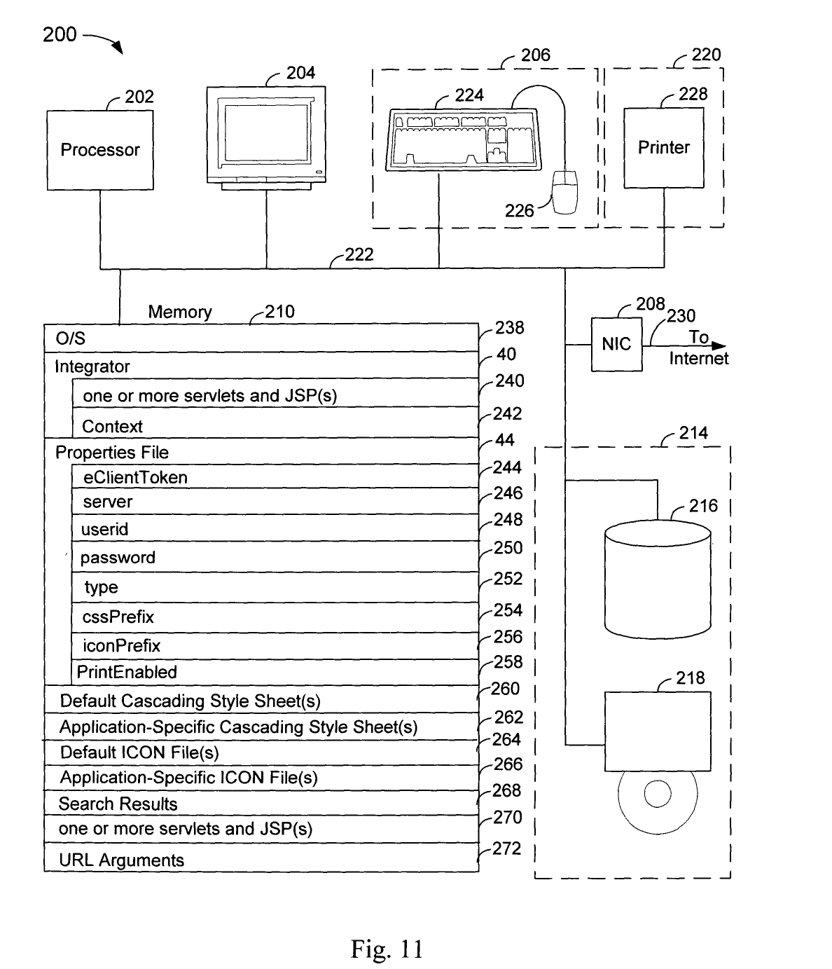

FIG. 11 depicts an illustrative computer system 200 that utilizes the teachings of the present invention. The computer system 200 comprises a processor 202, display 204, input interfaces (I/F) 206, communications interface 208, memory 210, disk memories 214 such as hard disk drive 216 and optical disk drive 218, and output interface(s) 220, all conventionally coupled by one or more busses 222. The input interfaces 206 comprise a keyboard 224 and mouse 226. The output interface is a printer 228. The communications interface 208 is a network interface card (NIC) that allows the computer 200 to communicate via a network, such as the Internet 230.

The memory 210 generally comprises different modalities, illustratively semiconductor memory, such as random access memory (RAM), and disk drives. The memory 210 stores operating system (O/S) 238 and application programs such as the integrator 40. The O/S 238 may be implemented by any conventional operating system, such as z/OS® (Registered Trademark of International Business Machines Corporation), AIX® (Registered Trademark of International Business Machines Corporation), Linux® (Registered Trademark of Linus Torvalds), UNIX® (UNIX is a registered trademark in the United States and other countries licensed through X/Open Company Limited), and Windows® (Registered Trademark of Microsoft Corporation).

The software modules are comprised of instructions which, when loaded into the memory 210, are executed by the processor 202. Generally, the software is tangibly embodied in a computer-readable medium, for example, memory 210 or, more specifically, one of the disk drives 214, and is comprised of instructions which, when executed, by the computer system 200, causes the computer system 200 to utilize the present invention. In one embodiment, the software modules of the present invention are implemented in the Java® (Java is a registered trademark of Sun Microsystems, Inc.) language. In alternate embodiments, languages other than Java® may be used.

The memory 210 stores software modules and data. In one embodiment, the memory 210 may store a portion of the software modules and data in semiconductor memory, while other software modules and data are stored in disk memory. In some embodiments, the memory 210 stores the following:
the operating system (O/S) 238;
the integrator 40, which in one embodiment is a servlet, and in an alternate embodiment, comprises one or more servlets and JavaServer Pages 240 to generate a web page;
a context 242 to store values of the properties and settings from the properties file;
one or more properties files 44 specifying the eClientToken 244, server 246, userid 248, password 250, the type setting 252, the cssPrefix setting 254, the iconPrefix setting 256 and the PrintEnabled setting 258;
a default cascading style sheet 260;
one or more application-specific cascading style sheets 262 to be specified by an external web application;
a set of default icon files 264 to be used to display graphics in the web page; in an alternate embodiment, no icon files are used;
one or more sets of application-specific icon files 266 that are specified by an external web application;
search results 268;
one or more servlets and JavaServer Pages 270 to generate a web page in an alternate embodiment; and
the arguments from the URL 272 that were received from an external application.

In yet another embodiment, to modify the “look and feel” of a web page, very little, or no code, may need to be modified. The predefined files such as the properties file, the cascading style sheet file, and the icon files can be modified.

The invention has been described by way of specific embodiments, but those skilled in the art will understand that various changes in form and detail may be made without deviating from the spirit or scope of the invention.

1. A method of controlling at least one of a presentation format and a behavior of a web page of a web application comprising:
in response to a request from a first web application having a first web page having a first presentation format and a first behavior, the request specifying at least one setting, generating a second web page, by a second web application external to the first web application, the second web page having a second presentation format and a second behavior, the second web page being generated in accordance with the at least one setting, wherein the at least one setting controls, at least in part, at least one of the second presentation format and the second behavior.

2. The method of claim 1 wherein the at least one setting causes the second presentation format and the second behavior to be substantially similar to the first presentation format and the first behavior, respectively.

3. The method of claim 1 further comprising:
first invoking the first web application to provide a first set of data in the first web page having the first presentation format and the first behavior;
second invoking, from the first web application, the second web application to provide a second set of data, wherein said first generating generates the second web page comprising at least a subset of the second set of data having, at least in part, at least one of the second presentation format and the second behavior in accordance with the at least one setting.

4. The method of claim 1, wherein the second web page is displayed within the first web page.

5. The method of claim 1 wherein the second web page is displayed outside the first web page.

6. The method of claim 1 wherein the at least one setting comprises at least one setting selected from the group consisting of a graphics setting, a style sheet setting, and a type setting.

7. The method of claim 1 wherein the request specifies a properties file, and the at least one setting is specified in the properties file.

8. The method of claim 7 wherein the at least one setting comprises at least one setting selected from the group consisting of a type setting, a graphics setting and a style sheet setting.

9. The method of claim 1 wherein the at least one setting comprises a print enabled setting to cause a print button to be displayed to allow the second set of data to be printed.

10. An apparatus for controlling at least one of a presentation format and a behavior of a web page of a web application, comprising:
a computer; and
one or more computer programs, executed by the computer, for integrating web applications comprising:
in response to a request from a first web application having a first web page having a first presentation format and a first behavior, the request specifying at least one setting, generating a second web page, by a second web application external to the first web application, the second web page having a second presentation format and a second behavior, the second web page being generated in accordance with the at least one setting, wherein the at least one setting controls, at least in part, at least one of the second presentation format and the second behavior.

11. The apparatus of claim 10 wherein the at least one setting causes the second presentation format and the second behavior to be substantially similar to the first presentation format and the first behavior, respectively.

12. The apparatus of claim 10 wherein said one or more computer programs is also for:
first invoking the first web application to provide a first set of data in the first web page having the first presentation format and the first behavior;
second invoking, from the first web application, the second web application to provide a second set of data, wherein said first generating generates the second web page comprising at least a subset of the second set of data having, at least in part, at least one of the second presentation format and the second behavior in accordance with the at least one setting.

13. The apparatus of claim 10 wherein the second web page is displayed within the first web page.

14 The apparatus of claim 10 wherein the second web page is displayed outside of the first web page.

15. The apparatus of claim 10 wherein the at least one setting comprises at least one setting selected from the group consisting of a graphics setting, a style sheet setting and a type setting.

16. The apparatus of claim 10 wherein the request specifies a properties file, and the at least one setting is specified in the properties file.

17. The apparatus of claim 16 wherein the at least one setting comprises at least one setting selected from the group consisting of a type setting, a graphics setting and a style sheet setting.

18. The apparatus of claim 10 wherein the at least one setting comprises a print-enabled setting to cause a print button to be displayed to allow the second set of data to be printed.

19. An article of manufacture comprising a computer program carrier readable by a computer and embodying one or more instructions executable by the computer to perform a method of controlling a presentation format and a behavior of a web application, the method comprising:
in response to a request from a first web application having a first web page having a first presentation format and a first behavior, the request specifying at least one setting, generating a second web page, by a second web application external to the first web application, the second web page having a second presentation format and a second behavior, the second web page being generated in accordance with the at least one setting, wherein the at least one setting controls, at least in part, at least one of the second presentation format and the second behavior.

20. The article of manufacture of claim 19 wherein the at least one setting causes the second presentation format and the second behavior to be substantially similar to the first presentation format and the first behavior, respectively.

21. The article of manufacture of claim 19 wherein the method further comprises:
first invoking the first web application to provide a first set of data in the first web page having the first presentation format and the first behavior; and
second invoking, from the first web application, the second web application to provide a second set of data, wherein said first generating generates the second web page comprising at least a subset of the second set of data having, at least in part, at least one of the second presentation format and the second behavior in accordance with the at least one setting.

22. The article of manufacture of claim 19 wherein the second web page is displayed within the first web page.

23. The article of manufacture of claim 19 wherein the second web page is displayed outside the first web page.

24. The article of manufacture of claim 19 wherein the at least one setting comprises at least one setting selected from the group consisting of a graphics setting, a style sheet setting and a type setting and a print enabled setting.

25. The article of manufacture of claim 19 wherein the request specifies a properties file, and the at least one setting is specified in the properties file.

26. The article of manufacture of claim 25 wherein the at least one setting comprises at least one setting selected from the group consisting of a type setting, a graphics setting and a style sheet setting.

27. The article of manufacture of claim 19 wherein the at least one setting comprises a print-enabled setting to cause a print button to be displayed to allow the second set of data to be printed.
